(19) United States
(12) Patent Application Publication
(10) Pub. No.: US 2017/0119209 A1
(43) Pub. Date: May 4, 2017

(54) ROTISSERIE MOTOR AND SKEWER HOLDER ASSEMBLY THAT INSERTS BETWEEN THE UPPER AND LOWER PARTS OF A COOKING OR SMOKING UNIT

(71) Applicant: William Jenks, Austin, TX (US)

(72) Inventor: William Jenks, Austin, TX (US)

(21) Appl. No.: 14/929,274

(22) Filed: Oct. 31, 2015

(51) Int. Cl. A47J 37/04

(52) U.S. Cl. CPC A47J 37/041; A47J 37/04

(57) ABSTRACT

A rotisserie device for use with a cooking unit, e.g., a kamado-type cooker, may include a rotisserie support unit that is removably insertable between a lower portion and an upper portion of the cooking unit, at least one opening or notch formed in the rotisserie support unit for receiving a rotisserie skewer, a lower engagement structure coupled to the rotisserie support unit and configured to rest on the lower portion of the cooking unit, and an upper engagement structure coupled to the rotisserie support unit and defining a rest for the upper portion of the cooking unit to rest thereon. The rotisserie support unit may define a wedge-shaped ring, e.g., for use with a hinged-style cooker, or may have any other suitable shape.

### TECHNICAL FIELD

The present invention relates primarily to rotisserie-style cooking on a cooking unit. More specifically, the present inventions is concerned with a rotisserie-style adaptor, or support unit, for various cooking units.

### BACKGROUND

Clay vessels have been used by humans to cook food for many thousands of years. Kamado-type cookers are fashioned after these circular clay cooking vessels. Modern versions are made from ceramic or metal for durability.

This circular-style cooking vessel allow air to enter at the bottom to fuel the cooking medium (usually coal,) and exit at the top. This manner of cooking allows for even temperature throughout the vessel. It is extremely versatile for grilling and smoking.

Rotisserie-style cooking is where the food (usually meat) is placed on a skewer called a spit, and rotates over a fire. This method allows the meat to cook evenly and self-baste as the juices from the meat run around the meat in rotation—as opposed to dripping off into the fire.

It may have been presumed that because the kamado-type cooking method cooks evenly, that cooking with a rotisserie was not necessary. However, this doe not take into consideration the full benefits of rotisserie-style cooking, for example the continuous self-basting in its own juices for moist meat, etc.

Heretofore, these two cooking methods have not been combined to take advantage of their individual qualities.

In another scenario, a typical BBQ grill may not have a built-in adaptor, or a place where a rotisserie motor might be attached for rotisserie-style cooking. Many newer cookers have holes pre-drilled into the base of the unit where a rotisserie motor may be attached at a later time.

In the event where there are no pre-existing holed drilled, or no potential place for a rotisserie motor attachment to be installed, an alternative instalment method must be used in order to take advantage of rotisserie-style cooking.

### SUMMARY

An embodiment of the invention is a rotisserie support unit configured to fit between the base and top of a cooker which allows the mounting of a rotisserie motor and skewer.

The design is a rotisserie support unit that rests on the rim of the base of the cooker. The rotisserie motor is attached to the rotisserie support unit on one side. Cut-outs in the rotisserie support unit material dip down on opposing edges of the rotisserie support unit (“skewer rests”), allowing the skewer to rest and rotate as the motor turns the skewer.

When the lid of the cooker is propped open, this allow the rotisserie support unit to be placed on the cooker. The rotisserie support unit may have a lower flange that protrudes from the bottom portion of the rotisserie support unit that allows the rotisserie support unit to rest on the base of the cooker. Once the rotisserie unit is in place on the base of the cooker, the food is ready to be added. The desired food is then placed on the skewer. One end of the skewer is inserted into the motor and the skewer is rested on the skewer rests.

The lid of the cooker can now be closed. The lid, when closed, rests upon the upper flange at the top of the rotisserie support unit. The gap that the rotisserie support unit creates between the base and the lid of the cooker gives the rotisserie support unit or enough room to hold the motor and skewer, allowing for rotisserie-style cooking.

### BRIEF DESCRIPTION OF THE DRAWINGS

Example embodiments of the invention are explained below with reference to the drawings, in which:

FIG. 1 shows a three-dimensional top view of a rotisserie support unit,

FIG. 2 shows another three-dimensional top view of the rotisserie support unit from an opposing angle,

FIG. 3 shows a three-dimensional top view of another embodiment of a rotisserie support unit,

FIG. 4 shows a three-dimensional top view of a motor and skewer being attached to a rotisserie support unit, according to an example embodiment,

FIG. 5 shows a three-dimensional top view of a rotisserie assembly including motor and skewer attached to a rotisserie support unit, according to an example embodiment,

FIG. 6 shows another view of the rotisserie assembly of FIG. 5,

FIG. 7 shows a rotisserie assembly being inserted into a kamado-style cooker, according to an example embodiment,

FIG. 8 relates to FIG. 7 and shows the rotisserie assembly resting on the base of the kamado-style cooker, with the cooker lid open,

FIG. 9 relates to FIGS. 7 and 8 and shows the rotisserie assembly resting on the base of the kamado-style cooker, with the cooker lid closed and resting on the rotisserie assembly, and

FIG. 10 is a side view of FIG. 9.

### DETAILED DESCRIPTION

As required, detailed embodiments of the present invention are disclosed herein; however, it is to be understood that the enclosed embodiments are merely exemplary of the principles of the invention, which may be embodied in various forms. Therefore, specific structural and functional details herein are not to be interpreted as limiting, but merely as a basis for the claims and as a representative basis for teaching one skilled in the art to variously employ the present invention in virtually any appropriately detailed structure. Moreover, the invention comprises any combination of claims and any combination of features disclosed by the claims.

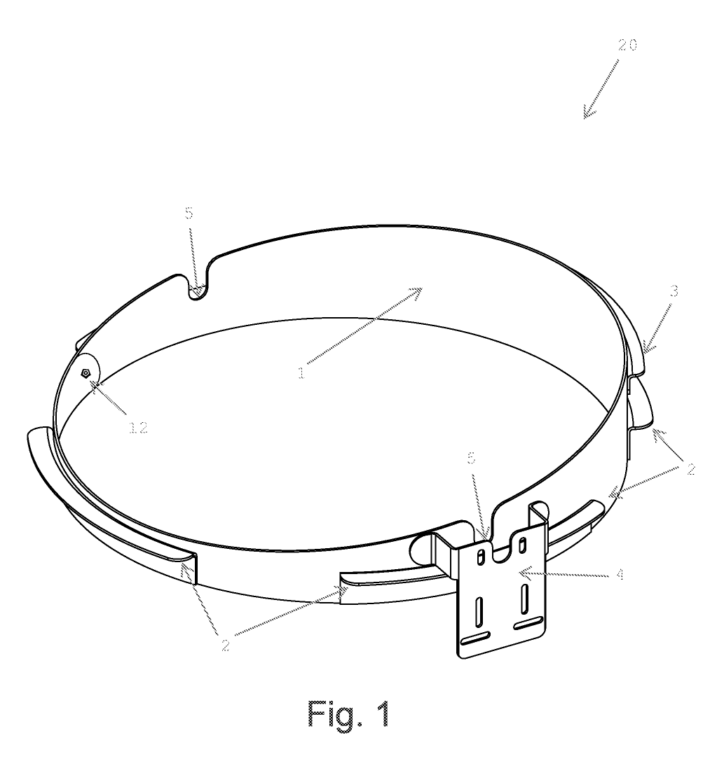

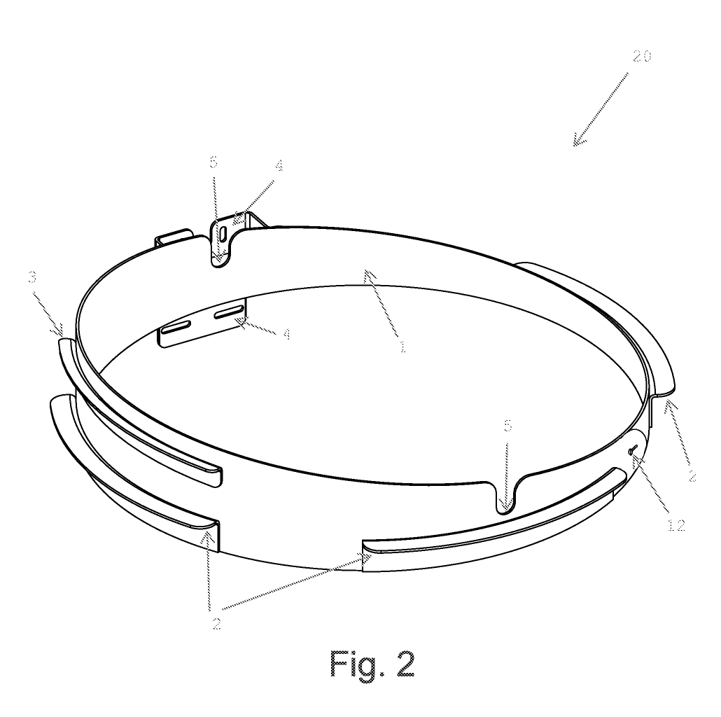

FIGS. 1 and 2 show one embodiment of a rotisserie support unit 20 that includes a support ring 1, with a lower flange 2 and an upper flange 3. The flanges 2 and 3 may be permanently or adjustably coupled to the support ring 1 in any suitable manner, e.g., welded to, connected to via adjustable fasteners, or formed integrally with the support ring 1. In this embodiment, flanges 2 and 3 are coupled to the outer side of the support ring 1, however, the flanges may be coupled to the inner side of the support ring 1 to suite the same purpose.

The flanges 2 and 3 may be arranged such that when the rotisserie support unit 20 is located in place between the lid and base portions of the cooking unit, with the lid resting on the upper flange, the lid is held open from the base portion by an angle of between 2-30 degrees. For example, in some embodiments, the rotisserie support unit 20 is configured to hold the lid open from the base portion by an angle of between 3-15 degrees. In particular embodiments, the rotisserie support unit 20 is configured to hold the lid open from the base portion by an angle of between 3-10 degrees.

A motor mount 4 may be coupled to the support ring 1. The embodiment of FIGS. 1 and 2 shows the motor mount 4 on the left side of the rotisserie support unit 20 (from a front view of a cooker in which the rotisserie support unit 20 is inserted); however the motor mount 4 can alternatively be mounted on the right side of the rotisserie support unit 20. Motor mount 4 can may be permanently or adjustably coupled to the support ring 1 in any suitable manner, e.g., welded to, connected to via adjustable fasteners, or formed integrally with the support ring 1.

Skewer rests 5, may be located on the opposing lateral sides of the rotisserie support unit 20, and may comprise openings or slots formed in the support ring 1. The skewer rests 5 may protrude down far enough so that when the cooker lid is lowered, there is enough room for the skewer to rotate unimpeded.

In this embodiment the support ring 1 has an adjustment system that allows a user to adjust the circumference of the support ring 1 to selectively size the support ring 1 for different size cookers. In particular, the support ring 1 is flexible and configured to overlap itself with a slot in one portion and a connector, in this embodiment a nut and screw 12, extending through the slot. The support ring 1 can be adjusted through a range of circumferences (corresponding to the length of the slot) and then fixed using the connector (i.e., by tightening the screw 12).

Support ring 1 may have any suitable cross-sectional shape, e.g., a circular shape, elliptical shape, oblong shape, rectangular shape, square shape, hexagonal shape, octagonal shape, or any other cross-sectional shape. The example embodiments shown in the figure have a circular or elliptical cross-sectional shape.

Further, along a side view, in some embodiments the support ring 1 has a wedge shape designed to fit between the lid and base portions of a cooker that are connected by a hinged connection, e.g., as shown in the example embodiments shown in the figures. In some embodiments, the wedge shape of the support ring 1 defines an angle of between 2-30 degrees. For example, in some embodiments, the wedge shape of the support ring 1 defines an angle of 3-15 degrees. In particular embodiments, the wedge shape of the support ring 1 defines an angle of between 3-10 degrees. In other embodiments, the support ring 1 is not wedged shape along the side view, e.g., the upper and lower ring-shaped edges of the support ring 1 may extend in parallel planes.

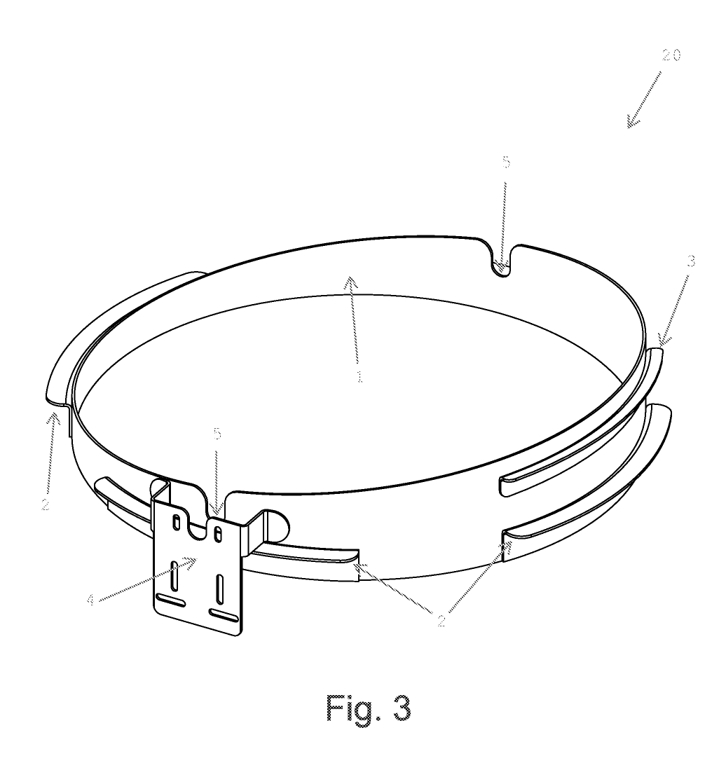

FIG. 3 illustrates an alternative embodiment in which the support ring 1 is continuous, non-overlapping ring, such that the circumference is non-adjustable.

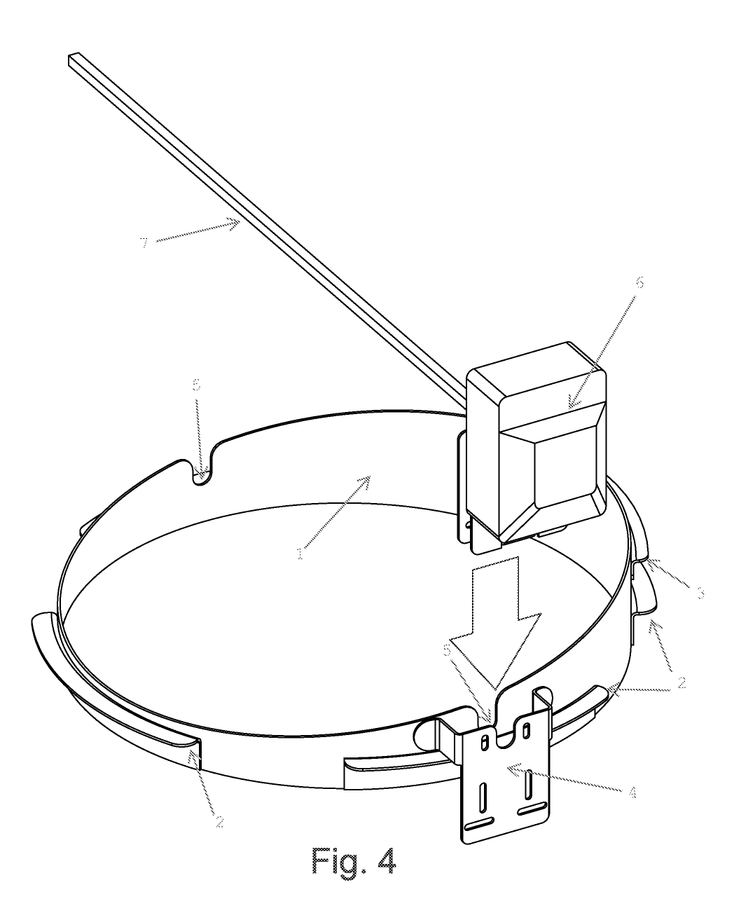

FIG. 4 shows an example embodiment (e.g., the embodiment of FIGS. 1-2 or FIG. 3) with rotisserie motor 6 and skewer 7 being inserted onto the motor mount 4. The motor 6 can be slid down onto the motor mount 4, or fastened to the motor mount 4 by bolts.

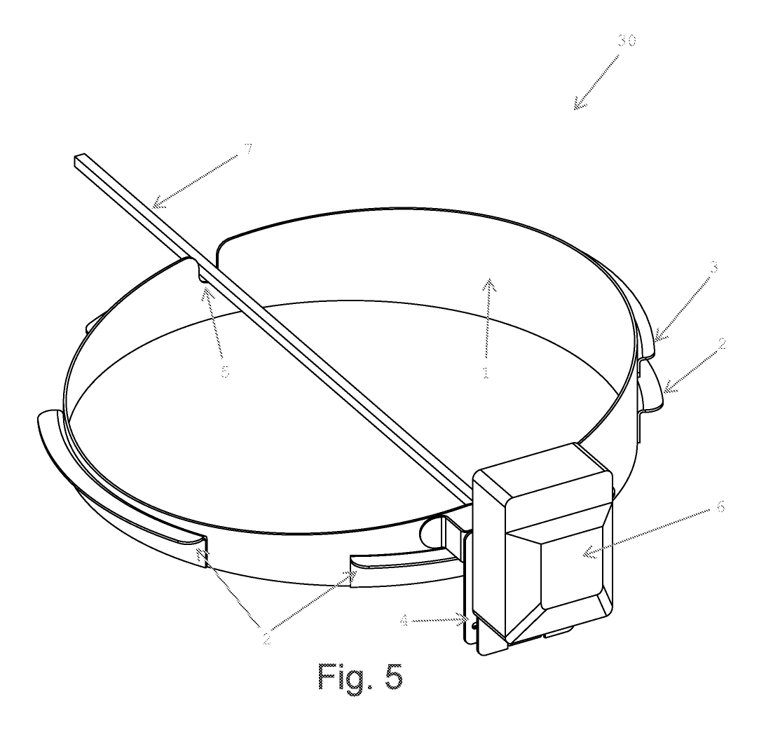

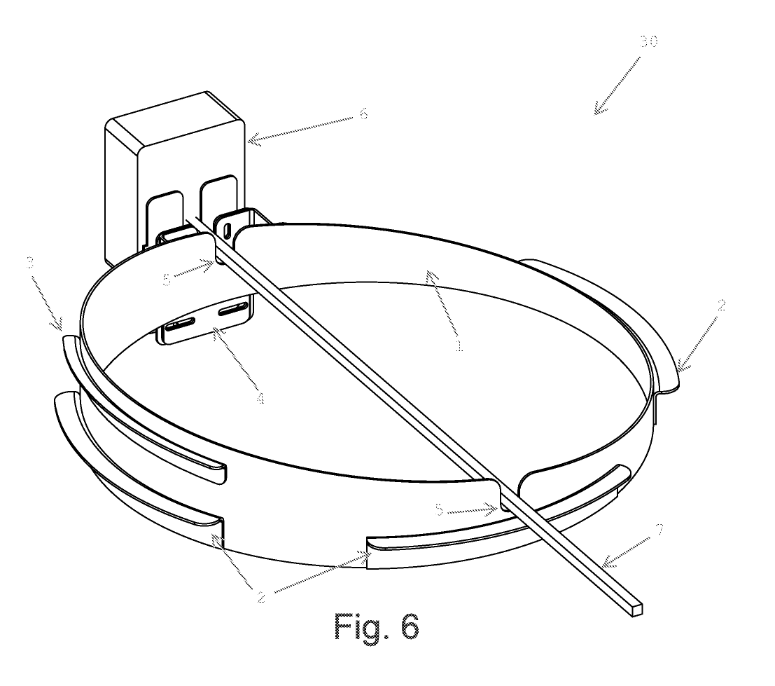

FIGS. 5 and 6 show a rotisserie assembly 30, which comprises the rotisserie support unit 20 discussed above, along with the rotisserie motor 6 fastened to the motor mount 4 and the skewer 7 rested on the skewer rests 5.

Each of the components of the rotisserie support unit 20, can be formed in any suitable manner and from any suitable material, for example, metal, aluminium, stainless steel, etc.

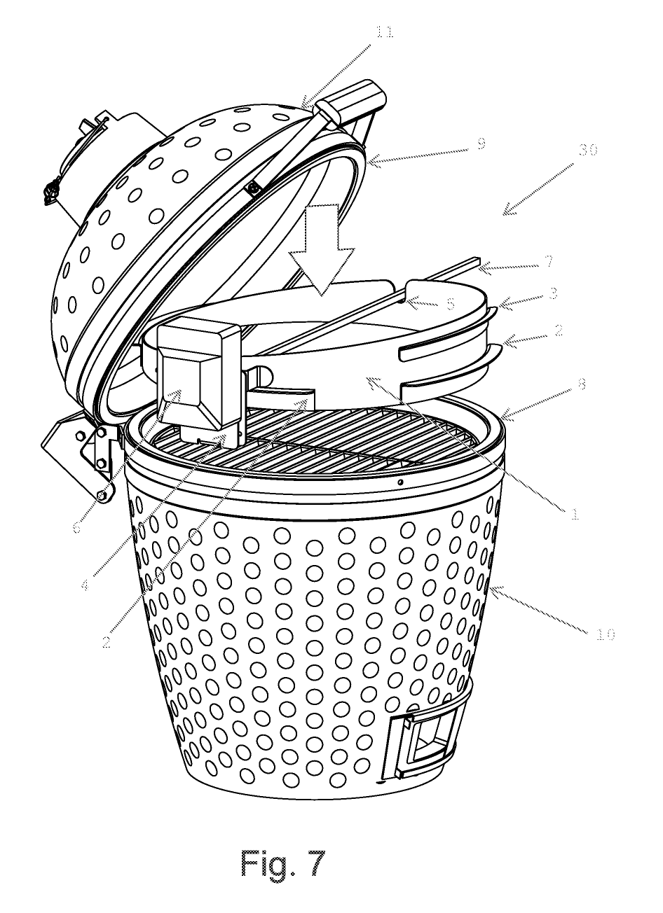

FIG. 7 shows an example embodiment of the rotisserie assembly 30 being inserted onto a cooker 10, where the lower flange 2 will rest on the base of the cookers top rim 8. Once inserted, the lid of the cooker 11 will then close on the rotisserie support unit 20 where the bottom rim of the lid 9 will rest on the upper flange 2.

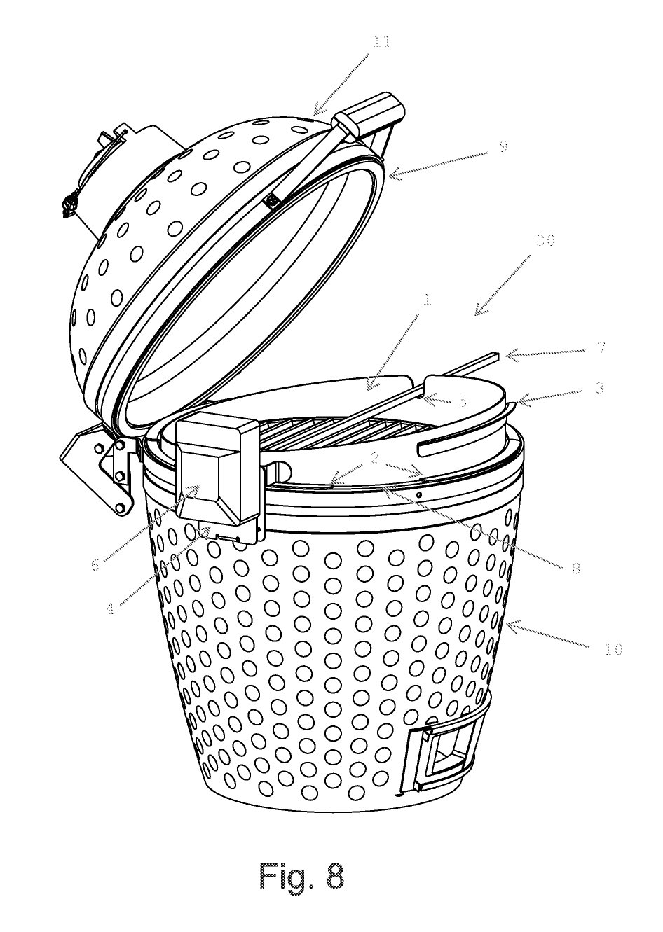

FIG. 8 is similar to FIG. 7 but shows the rotisserie assembly 30 resting on a rim defined by the base portion of the cooker rim 8; in particular, the lower flange 2 of the rotisserie support unit 20 may rest on cooker rim 8. This is the placement of the rotisserie assembly 30 when the food is put on the skewer and inserted into the motor for cooking.

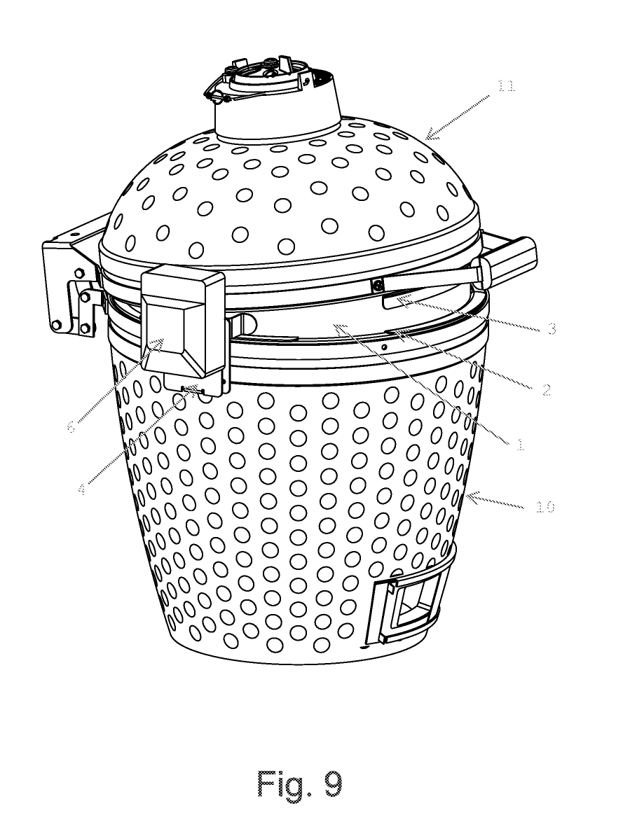

FIG. 9 is similar to FIG. 8 but shows the cooker lid 11 closed and resting on the upper flange 3 of the rotisserie support unit 20. This is the placement of the rotisserie assembly 30 when cooking food.

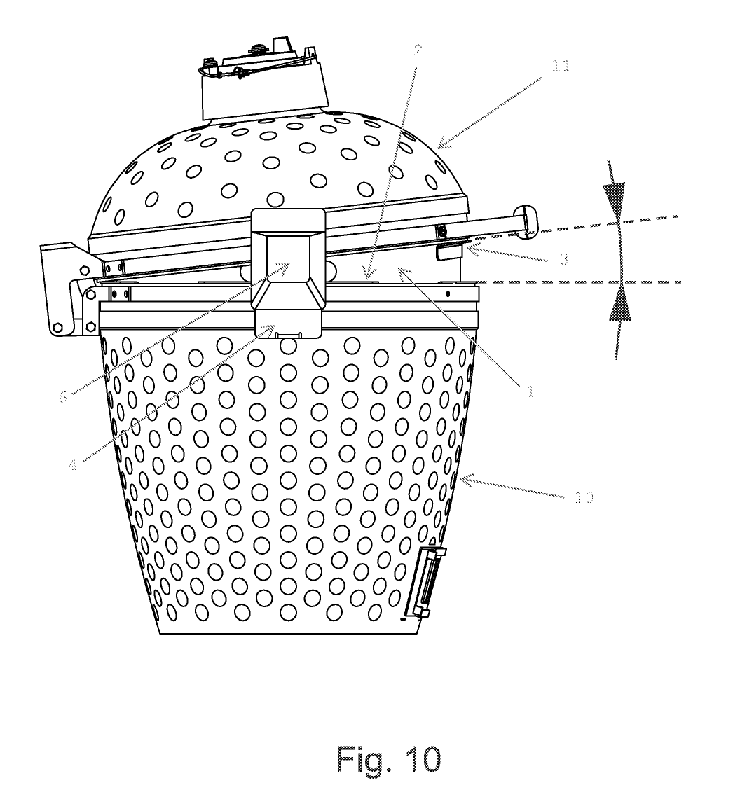

FIG. 10 is a side view of FIG. 9. As shown, with the rotisserie support unit 20 inserted and the cooker lid 11 closed, with the lid 11 resting at a non-parallel angle with respect to the base portion of the cooker 10. The angle of the closed lid 11 may be defined by the shape and size of the rotisserie support unit 20.

What is claimed is:

1. A rotisserie device configured for use with a cooking unit, the rotisserie device comprising:
a rotisserie support unit configured for removable insertion between a lower portion and an upper portion of the cooking unit;
at least one opening or notch formed in the rotisserie support unit and configured to receive a rotisserie skewer;
a lower engagement structure coupled to the rotisserie support unit and configured to rest on the lower portion of the cooking unit; and
an upper engagement structure coupled to the rotisserie support unit and defining a rest for the upper portion of the cooking unit to rest thereon.

2. The rotisserie device of claim 1, further comprising a motor support unit coupled to the rotisserie support unit and configured to receive and support a rotisserie motor.

3. The rotisserie device of claim 1, wherein the lower engagement structure comprises a flange extending laterally from the rotisserie support unit.

4. The rotisserie device of claim 1, wherein the upper engagement structure comprises a flange extending laterally from the rotisserie support unit.

5. The rotisserie device of claim 1, wherein the rotisserie support unit has a wedge shape.

6. The rotisserie device of claim 1, wherein the rotisserie support unit defines a wedge-shaped ring.

7. The rotisserie device of claim 1, wherein the rotisserie support unit defines a ring and comprises an adjustment system configured for adjusting a circumference of the ring.

8. A rotisserie device configured for use with a cooking unit, the rotisserie device comprising:
a rotisserie support unit configured for removable insertion between a lower portion and an upper portion of the cooking unit;
a lower engagement structure coupled to the rotisserie support unit and configured to rest on the lower portion of the cooking unit;
an upper engagement structure coupled to the rotisserie support unit and defining a rest for the upper portion of the cooking unit to rest thereon;
a rotisserie skewer;
at least one rotisserie skewer opening or rotisserie skewer notch formed in the rotisserie support unit and configured to receive the rotisserie skewer;
a rotisserie motor; and
a motor support unit coupled to the rotisserie support unit and configured to receive and support the rotisserie motor.

9. A cooking system, comprising:
a cooking unit having a lower portion and an upper portion pivotally coupled to the lower portion; and
a rotisserie device, comprising:
a rotisserie support unit configured for removable insertion between the lower portion and the upper portion of the cooking unit;
at least one opening or notch formed in the rotisserie support unit and configured to receive a rotisserie skewer;
a lower engagement structure coupled to the rotisserie support unit and configured to rest on the lower portion of the cooking unit; and
an upper engagement structure coupled to the rotisserie support unit and defining a rest for the upper portion of the cooking unit to rest thereon.

10. The cooking system of claim 9, further comprising the rotisserie skewer.

11. The cooking system of claim 9, wherein the rotisserie device further comprises a motor support unit coupled to the rotisserie support unit and configured to receive and support a rotisserie motor.

12. The cooking system of claim 11, further comprising the rotisserie motor.
